(19) United States
(12) Patent Application Publication
(10) Pub. No.: US 2015/0106041 A1
(43) Pub. Date: Apr. 16, 2015

(54) NOTIFICATION BASED ON AN EVENT IDENTIFIED FROM VIBRATION DATA

(71) Applicants: Charles Edgar Bess, Frisco, TX (US); Abhay Mehta, Austin, TX (US); Henri J. Suermondt, Sunnyvale, CA (US)

(72) Inventors: Charles Edgar Bess, Frisco, TX (US); Abhay Mehta, Austin, TX (US); Henri J. Suermondt, Sunnyvale, CA (US)

(73) Assignee: Hewlett-Packard Development Company, Houston, TX (US)

(21) Appl. No.: 14/397,705

(22) PCT Filed: Apr. 30, 2012
(86) PCT No.: PCT/US2012/035772

§ 371 Date: Oct. 29, 2014

(51) Int. Cl. G01H 11/06; G01P 15/125

(52) U.S. Cl. CPC G01H 11/06; G01P 15/125
USPC 702/56

(57) ABSTRACT

A system includes at least three accelerometers disposed in different locations of an area to capture respective vibration data corresponding to an event and a processing system to receive the vibration data from each accelerometer and generate a notification based on the event and a location of the event identified from the vibration data.

### BACKGROUND

Users of devices often seek to perform diagnostics and maintenance on the devices before major failures occur. Without paying close attention to a device, the user may have little sense of the actual operating state of the device. The device, however, may be providing clues about its internal workings from the vibrations it emits. For example, a dirty fan or filter or worn bearings of a device may produce vibrations from the device that differ from the vibrations during normal operation. Although vibration sensors may be attached to some devices, the capabilities of such sensors are typically limited to the devices to which they are attached.

### BRIEF DESCRIPTION OF THE DRAWINGS

FIG. 1 is a schematic diagram illustrating one embodiment of a system for generating notifications for events identified from vibration data captured by accelerometers.

FIG. 2 is a flow chart illustrating one embodiment of a method for generating notifications for events identified from vibration data captured by accelerometers.

FIG. 3 is a flow chart illustrating one embodiment of a method for processing vibration data to identify an event and a location of the event.

FIG. 4 is a flow chart illustrating one embodiment of a method for monitoring events identified from vibration data captured by accelerometers.

FIG. 5 is a block diagram illustrating one embodiment of a system for generating notifications for events identified from vibration data captured by accelerometers.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a system detects events in an area using accelerometers and provides notifications corresponding to the events to users. The system includes at least three accelerometers disposed in the area that capture respective vibration data corresponding to events. The accelerometers each provide the captured vibration data to a processing system that identifies the events and locations of the events from the vibration data (e.g., by triangulation). The processing system generates notifications based on the events and the event locations and provides the notifications to users.

Vibrations from an event in the area transmit to the accelerometers through any solid structures (e.g., floors, walls, ceilings, or other structures in the area) between the event source (e.g., a device or a person) and the accelerometers. The accelerometers capture the vibrations of events in the vibration data and provide the vibration data to the processing system. The accelerometers form a data network that enables the processing system to correlate and analyze the vibration data from the accelerometers in a coordinated manner.

By analyzing and triangulating the vibration data, the processing system can evaluate and assess events that occur in the area. In particular, the processing system evaluates indicative vibrations in the vibration data to determine whether the indicative vibrations provide early indications of noteworthy events. The processing system may compare the events and event locations to normal or expected vibration patterns of the area to determine whether events are significant. The processing system may also associate events with a device or person known to be in a location where the event occurs. By doing so, the processing system can determine that events are associated with devices, such as computers, refrigerators, furnaces, air conditioners, or other major appliances, that may not be operating normally (e.g., devices that may be about to fail) or associated with persons. Further, if processing system determines that an event is not associated with a known location of a device or other vibration source, the processing system may determine that the event (e.g., a fall or other activity) is associated with a person and notify authorities.

As used herein, the term vibration data refers to a set of data values that collectively represent the frequency and amplitude of the vibrations detected by an accelerometer over time.

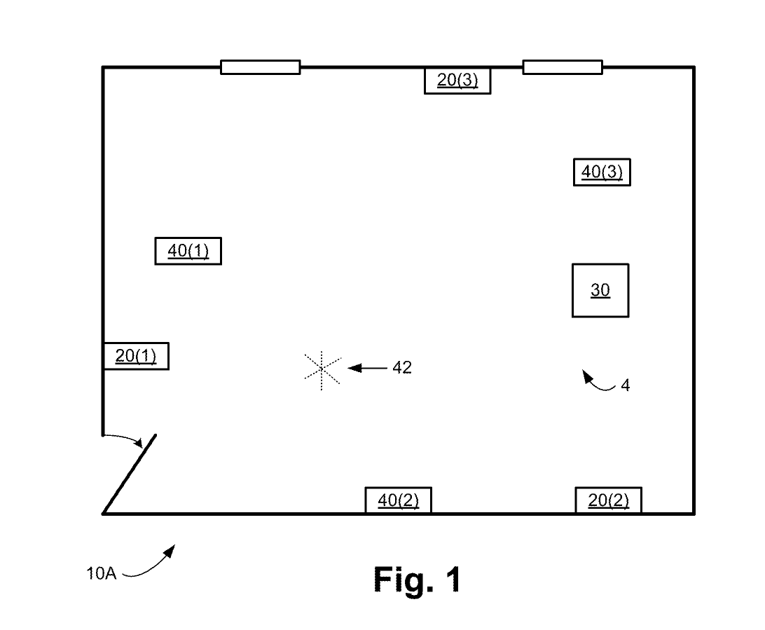

FIG. 1 is a schematic diagram illustrating one embodiment 10A of a system 10 for generating notifications for events identified from vibration data captured by accelerometers 20.

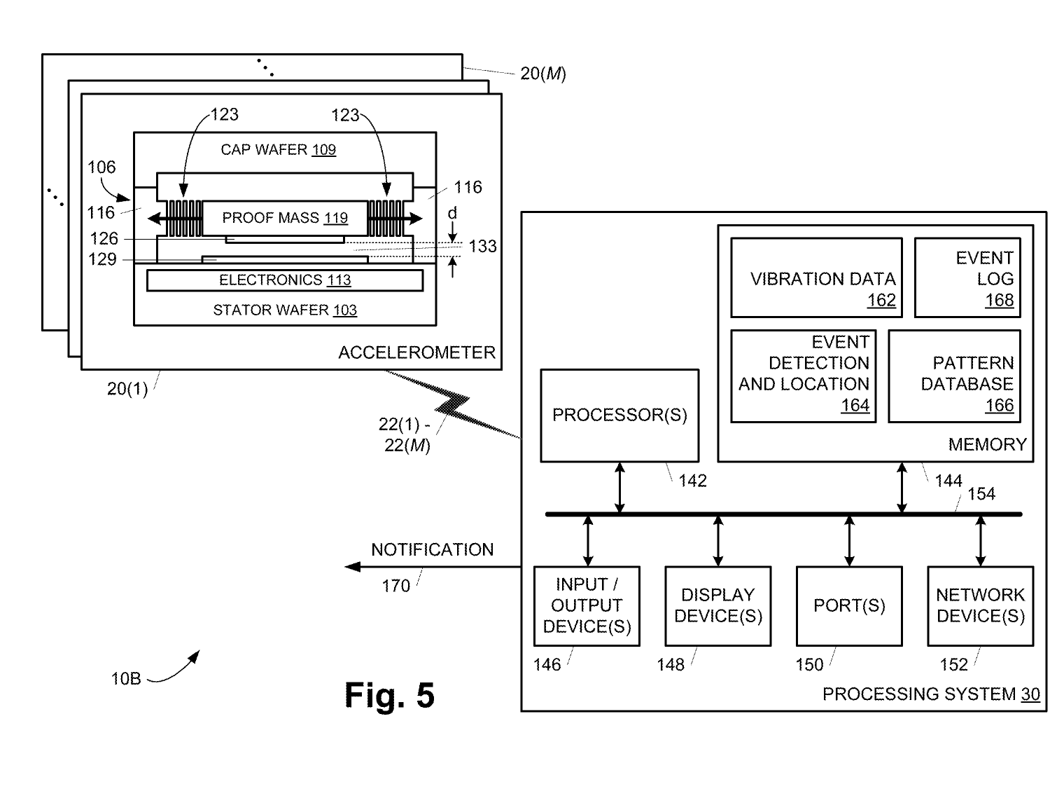

System 10 includes at least three accelerometers 20 (e.g., accelerometers 20(1), 20(2), and 20(3) as shown in the example of FIG. 1) disposed in different locations of an area 4. Each accelerometer 20 captures vibration data (shown collectively as vibration data 162 in the embodiment of FIG. 5) from vibrations present in area 4 and provides the vibration data to a processing system 30. The vibration data includes vibrations that represent events that occur in and around area 4. Processing system 30 identifies the events in the vibration data, identifies the locations of events using triangulation of the vibration data, and generates notifications (shown as notifications 170 in the embodiment of FIG. 5) based on the events and event locations. Processing system 30 provides or otherwise outputs the notifications to a user in any suitable way.

Events may occur anywhere in or around area 4 and may originate with one or more devices 40 (e.g., devices 40(1)-40(3) shown in the embodiment of FIG. 1), one or more persons (e.g., a patient in a healthcare facility having a seizure), or other vibration sources (not shown). Area 4 represents any suitable physical space that includes accelerometers 20 and possibly processing system 30 and one or more vibration sources such as devices 40 or persons. For example, area 4 may represent one or more rooms inside a home (e.g., a house, condominium, town house, or apartment), an office, a place of business, or a healthcare facility. Devices 40 may be disposed on any suitable structural components of area 4, such as floors, walls, ceilings, windows, and doors, and other structures, objects, and apparatus present in area 4.

Accelerometers 20 are disposed with a physical connection to one or more solid surfaces in area 4 to allow vibrations to transmit from the event locations to the surfaces in physical contact with accelerometers 20. The vibrations transmit though any solid materials of area 4 between the event locations and the surfaces in physical contact with accelerometers 20. In some embodiments, accelerometers 20 may be disposed on a foundation or other major structural components of a home or building to provide a continuous solid material contact with as many surfaces in area 4 as possible.

Accelerometers 20 are disposed in different locations of area 4 to allow processing system 30 to triangulate a location of an event. For example, accelerometers 20 may be placed at corners of a room in area 4 or other strategic locations in area 4. Because accelerometers 20 are disposed in different locations, accelerometers 20 typically capture vibration data from event locations at slightly different times as a result of the different distances between accelerometers 20 and an event location. Processing system 30 correlates events from the vibration data of the different accelerometers 20 and identifies the time differences between the events in order to triangulate an event location.

Each accelerometer 20 includes ultra-high sensitivity microfabricated accelerometer technology with three-phase sensing as described by U.S. Pat. Nos. 6,882,019, 7,142,500, and 7,484,411 and incorporated by reference herein in their entirety. Each accelerometer 20 is a sensor which detects acceleration, i.e., a change in a rate of motion, with a high sensitivity and dynamic range. Because of the three-phase sensing technology, each accelerometer 20 may sense acceleration levels as low as 10's of nano-gravities (ng) and may be manufactured and housed in a device that has typical dimensions of 5×5×0.5 mm or less using Micro-Electro-Mechanical-Systems (MEMS) technology. The combination of high sensitivity and small device size enabled by three-phase sensing techniques allows accelerometers 20 to unobtrusively capture vibration data that includes vibrations tapped by users 2 that represents commands for devices 40 without direct contact between any of accelerometers 20 and users 2. Accelerometers 20 provide vibration data to processing system 30 over any suitable wired or wireless connections (e.g., connections 22 shown in the embodiment of FIG. 5). Additional details of accelerometers 20 are shown and described with reference to FIG. 5 below.

Processing system 30 receives vibration data from each accelerometer 20 over the wired or wireless connections. Each event recognized by processing system 30 may be any vibration pattern generated by a vibration source and captured by accelerometers 20 in area 4. Processing system 30 includes or otherwise receives or accesses any suitable known vibration pattern information that includes a set of normal or expected vibration patterns and locations that occur in area 4 (e.g., pattern database 166 shown in the embodiment of FIG. 5). The set of patterns and locations may be captured by accelerometers 20 and processed by processing system 30 as part of a calibration or training method for identifying vibration patterns that occur in area 4. Processing system 30 compares events from the vibration data to the set of patterns and locations to determine whether to notify a user about an event. Processing system 30 may perform any suitable computation to assess, quantify, or determine an amount of similarity between the events from the vibration data and the set of patterns and locations.

The known vibration pattern information may also include device identification and location information that explicitly identifies a type of a device 40 present at a location in area 4. Processing system 30 may obtain the device information by allowing a user to register devices 40 in area 4. Based on an event location and the device information, processing system 30 may associate an event with a device 40 that is present at the event location.

In other embodiments, processing system 30 analyzes vibration data using on a set of rules or uses other analytical techniques to identify events.

Upon detecting an event, processing system 30 generates a notification and provides the notification to a user. Processing system 30 may provide the notification by storing a log of events for later review or analysis by a user (e.g., in an event log 168 shown in the embodiment of FIG. 5). Processing system 30 may also provide the notification by outputting the notification to the user through a display or other suitable device or by causing another device (not shown) to provide the notification to the user. Processing system 30 may include an indication of the event location in the notification in some embodiments.

Each device 40 represents any device that generates vibrations. Examples of devices 40 include computers, refrigerators, furnaces, air conditioners, or other major appliances. Devices 40 may move or be moved within area 4. Events may also be caused by a person or other vibration source 42 in area 4.

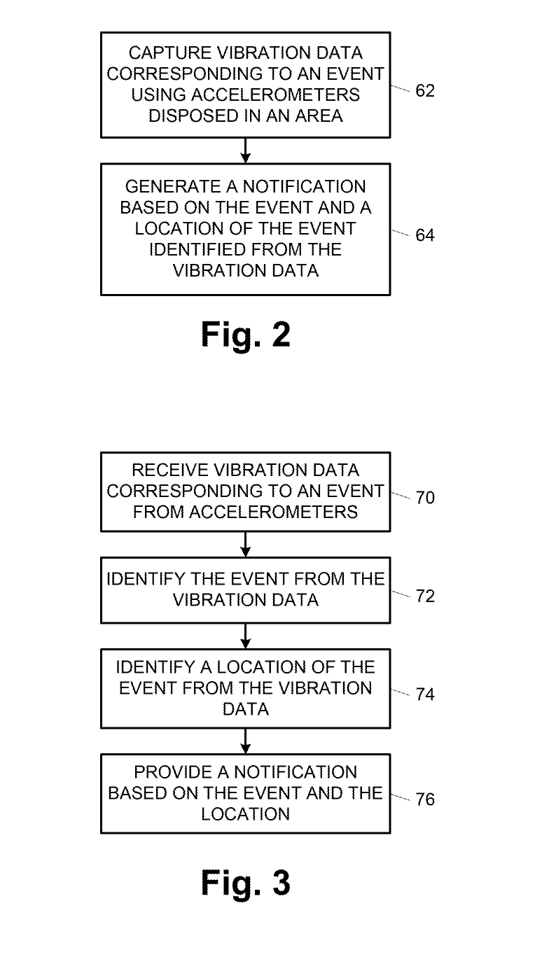

The functions of system 10 are further illustrated in FIG. 2 which is a flow chart illustrating one embodiment of a method for generating notifications for events identified from vibration data captured by accelerometers 20. In the embodiment of FIG. 2, accelerometers 20 disposed in area 4 capture vibration data corresponding to an event as indicated in a block 62. Each accelerometer 20 provides respective vibration data corresponding to the event to processing system 30. Processing system 30 generates a notification based on the event and an event location identified from the vibration data as indicated in a block 64. Processing system 30 triangulates the location of the event using the respective vibration data from accelerometers 20 and provides the notification to a user in any suitable way.

The functions of processing system 30 are further illustrated in FIG. 3 which is a flow chart illustrating one embodiment of a method for processing vibration data to identify an event and a location of the event. In the embodiment of FIG. 3, processing system 30 receives vibration data corresponding to an event from at least three accelerometers 20 as indicated in a block 70. Processing system 30 identifies the event from the vibration data as indicated in a block 72. Processing system 30 identifies an event location from the vibration data using triangulation as indicated in a block 74. Processing system 30 may identify the event and the event location by comparing the event and the location to a set of patterns and locations captured by accelerometers 20 prior to the event in one embodiment. Processing system 30 generates a notification based on the event and the event location and provides the notification to a user as indicated in a block 76. Processing system 30 generates the notification in response to comparing the event and the event location to a set of patterns and locations captured by the accelerometers prior to the event in one embodiment.

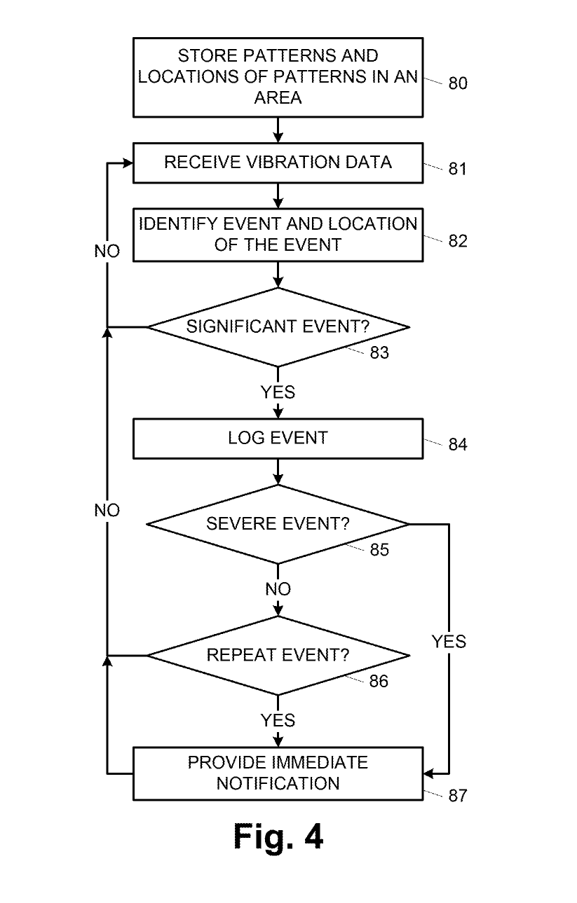

The functions of processing system 30 are further illustrated in FIG. 4 which is a flow chart illustrating one embodiment of a method for monitoring events identified from vibration data captured by accelerometers 20. In the embodiment of FIG. 4, processing system 30 stores patterns and locations of patterns in area 4 as indicated in a block 80. In one embodiment, processing system 30 processes vibration data captured by accelerometers 20 in area 4 to identify the patterns and locations and stores the set of patterns and locations as a pattern database (e.g., pattern database 166 shown in the embodiment of FIG. 5).

Processing system 30 receives vibration data from at least three accelerometers 20 that include an event as indicated in a block 81. Processing system 30 identifies the event and a location of the event as indicated in a block 82. Processing system 30 determines whether the event is a significant event as indicated in a block 83. In one embodiment, processing system 30 determines that an event is a significant event in response to comparing the event the set of patterns and locations and finding that the event differs substantially from each of patterns and/or locations in the set (i.e., the event is noteworthy compared to the events in the set). If the event is not significant, then processing system 30 continues receiving vibration data as indicated in block 81.

If the event is significant, then processing system 30 logs the event as indicated in a block 84 (e.g., by storing the event in event log 168 shown in FIG. 5). Processing system 30 also determines whether the event is severe, as indicated in a block 85, or is a repeat of a previous significant event, as indicated in a block 86. If the event is severe or a repeat, then processing system 30 provides an immediate notification to a user or other suitable person as indicated in a block 87. If not, then processing system 30 continues receiving vibration data as indicated in block 81.

FIG. 5 is a block diagram illustrating one embodiment 10B of system 10 for generating notifications 170 for events identified from vibration data 162 captured by accelerometers 20. System 10B includes accelerometers 20(1)-20(M), where M is an integer greater than or equal to three, in communication with processing system 30 across respective connections 22(1)-22(M). Processing system 30 receives vibration data 162 from accelerometers 20(1)-20(M) across connections 22(1)-22(M) that includes events and outputs notifications 170 based on the events and the locations of the events.

In the discussion below, accelerometer 20 refers to each accelerometer 20(1)-20(M) individually and accelerometers 20 refer to accelerometers 20(1)-20(M) collectively. Connection 22 refers to each connection 22(1)-22(M) individually and connections 22 refer to connections 22(1)-22(M) collectively.

In the embodiment of FIG. 5, accelerometer 20 includes three layers, or “wafers.” In particular, accelerometer 20 includes a stator wafer 103, a rotor wafer 106, and a cap wafer 109. Stator wafer 103 includes electronics 113 that may be electrically coupled to various electrical components in rotor wafer 106 and cap wafer 109. Also, electronics 113 may provide output ports for coupling to electronic components external to accelerometer 20.

Rotor wafer 106 includes support 116 that is mechanically coupled to a proof mass 119. Although the cross-sectional view of accelerometer 20 is shown, according to one embodiment, support 116 as a portion of rotor wafer 106 surrounds proof mass 119. Consequently, in one embodiment, stator wafer 103, support 116, and cap wafer 109 form a pocket within which proof mass 119 is suspended.

Together, stator wafer 103, support 116, and cap wafer 109 provide a support structure to which proof mass 119 is attached via a compliant coupling. The compliant coupling may, in one embodiment, comprise high aspect ratio flexural suspension elements 123 described in U.S. Pat. No. 6,882,019.

Accelerometer 20 further includes a first electrode array 126 that is disposed on proof mass 119. In one embodiment, first electrode array 126 is located on a surface of proof mass 119 that is opposite the upper surface of stator wafer 103. The surface of the proof mass 119 upon which the first electrode array 126 is disposed is a substantially flat surface.

A second electrode array 129 is disposed on a surface of stator wafer 103 facing opposite first electrode array 126 disposed on proof mass 119. Because proof mass 126 is suspended over stator wafer 103, a substantially uniform gap 133 (denoted by d) is formed between first electrode array 126 and second electrode array 129. The distance d may comprise, for example, anywhere from 1 to 3 micrometers, or it may be another suitable distance.

Proof mass 119 is suspended above stator wafer 103 so that first electrode array 126 and second electrode array 129 substantially fall into planes that are parallel to each other and gap 133 is substantially uniform throughout the overlap between first and second electrode arrays 126 and 129. In other embodiments, electrode arrays 126 and 129 may be placed on other surfaces or structures of stator wafer 103 or proof mass 119.

High aspect ratio flexural suspension elements 123 offer a degree of compliance that allows proof mass 119 to move relative to the support structure of accelerometer 20 (not shown). Due to the design of flexural suspension elements 123, the displacement of proof mass 119 from a rest position is substantially restricted to a direction that is substantially parallel to second electrode array 129, which is disposed on the upper surface of stator wafer 103. Flexural suspension elements 123 are configured to allow for a predefined amount of movement of proof mass 119 in a direction parallel to second electrode array 129 such that gap 133 remains substantially uniform throughout the entire motion to the extent possible. The design of flexural suspension elements 123 provides for a minimum amount of motion of proof mass 119 in a direction orthogonal to second electrode array 129 while allowing a desired amount of motion in the direction parallel to second electrode array 129.

As proof mass 119 moves, capacitances between first and second electrode arrays 126 and 129 vary with the shifting of the arrays with respect to each other. Electronics 113 and/or external electronics are employed to detect or sense the degree of the change in the capacitances between electrode arrays 126 and 129. Based upon the change in the capacitances, such circuitry can generate appropriate signals that are proportional to the vibrations from patient 2 experienced by accelerometer 20.

The operation of accelerometer 20 is enhanced by the use of three-phase sensing and actuation as described by U.S. Pat. Nos. 6,882,019 and 7,484,411. Three-phase sensing uses an arrangement of sensing electrodes 126 and 129 and sensing electronics 113 to enhance the output signal of accelerometer 20 and allow for the sensitivity to be maximized in a desired range. It also allows the output of accelerometer 20 to be “reset” to zero electronically when the sensor is in any arbitrary orientation.

Processing system 30 represents any suitable processing device, or portion of a processing device, configured to implement the functions of the method shown in FIG. 5 and described above. A processing device may be a laptop computer, a tablet computer, a desktop computer, a server, or another suitable type of computer system. A processing device may also be a mobile telephone with processing capabilities (i.e., a smart phone) or another suitable type of electronic device with processing capabilities. Processing capabilities refer to the ability of a device to execute instructions stored in a memory 144 with at least one processor 142. Processing system 30 represents one of a plurality of processing systems in a cloud computing environment in one embodiment.

Processing system 30 includes at least one processor 142 configured to execute machine readable instructions stored in a memory system 144. Processing system 30 may execute a basic input output system (BIOS), firmware, an operating system, a runtime execution environment, and/or other services and/or applications stored in memory 144 (not shown) that includes machine readable instructions that are executable by processors 142 to manage the components of processing system 30 and provide a set of functions that allow other programs to access and use the components. Processing system 30 stores vibration data 162 received from accelerometers 20 in memory system 144 along with event detection and location unit 164 that identifies events from vibration data 162 and locations of the events from vibration data 162 and generates and outputs notifications 170 based on the events and event locations as described above with reference to FIGS. 1-4. Processing system 30 further stores pattern database 166 and event log 168 in some embodiments.

Processing system 30 may also include any suitable number of input/output devices 146, display devices 148, ports 150, and/or network devices 152. Processors 142, memory system 144, input/output devices 146, display devices 148, ports 150, and network devices 152 communicate using a set of interconnections 154 that includes any suitable type, number, and/or configuration of controllers, buses, interfaces, and/or other wired or wireless connections. Components of processing system 30 (for example, processors 142, memory system 144, input/output devices 146, display devices 148, ports 150, network devices 152, and interconnections 154) may be contained in a common housing with accelerometer 20 (not shown) or in any suitable number of separate housings separate from accelerometer 20 (not shown).

Each processor 142 is configured to access and execute instructions stored in memory system 144 including command unit 164. Each processor 142 may execute the instructions in conjunction with or in response to information received from input/output devices 146, display devices 148, ports 150, and/or network devices 152. Each processor 142 is also configured to access and store data, including vibration data 162, pattern database 166, and event log 168, in memory system 144.

Memory system 144 includes any suitable type, number, and configuration of volatile or non-volatile storage devices configured to store instructions and data. The storage devices of memory system 144 represent computer readable storage media that store computer-readable and computer-executable instructions including event detection and location unit 164. Memory system 144 stores instructions and data received from processors 142, input/output devices 146, display devices 148, ports 150, and network devices 152. Memory system 144 provides stored instructions and data to processors 142, input/output devices 146, display devices 148, ports 150, and network devices 152. Examples of storage devices in memory system 144 include hard disk drives, random access memory (RAM), read only memory (ROM), flash memory drives and cards, and other suitable types of magnetic and/or optical disks.

Input/output devices 146 include any suitable type, number, and configuration of input/output devices configured to input instructions and/or data from a user to processing system 30 and output instructions and/or data from processing system 30 to the user. Examples of input/output devices 146 include a touchscreen, buttons, dials, knobs, switches, a keyboard, a mouse, and a touchpad.

Display devices 148 include any suitable type, number, and configuration of display devices configured to output image, textual, and/or graphical information to a user of processing system 30. Examples of display devices 148 include a display screen, a monitor, and a projector. Ports 150 include suitable type, number, and configuration of ports configured to input instructions and/or data from another device (not shown) to processing system 30 and output instructions and/or data from processing system 30 to another device.

Network devices 152 include any suitable type, number, and/or configuration of network devices configured to allow processing system 30 to communicate across one or more wired or wireless networks (not shown). Network devices 152 may operate according to any suitable networking protocol and/or configuration to allow information to be transmitted by processing system 30 to a network or received by processing system 152 from a network.

Connection 22 includes any suitable type and combination of wired and/or wireless connections that allow accelerometer 20 to provide vibration data 162 to processing system 30. Connection 22 may connect to one or more ports and/or one or more network devices 152 of processing system 30. For example, connection 22 may comprise a wireless network connection that includes a wireless network device (not shown) that transmits vibration data 162 from accelerometer 20 to processing system 30. As another example, connection 22 may comprise a cable connected from accelerometer 20 to a port 150 to transmit vibration data 162 from accelerometer 20 to processing system 30.

The above embodiments may advantageously provide a user with notification of events that occur in an area. The events may include noteworthy operations of devices or circumstances that occur in the area. The embodiments may allow a user to react to the events more quickly to minimize repair costs of devices or otherwise remedy situations involving noteworthy circumstances. The embodiments may involve minimal configurations by a user and may be easily reconfigured (e.g., by the movement of devices in the area) to suit changing situations of a user.

What is claimed is:

1. A system comprising:
at least three accelerometers disposed in different locations of an area to capture respective vibration data corresponding to an event; and
a processing system to receive the vibration data from each accelerometer and generate a notification based on the event and on a location of the event identified from the vibration data.

2. The system of claim 1 wherein the processing system is to generate the notification in response to comparing the event and the location to a set of patterns and locations captured by the accelerometers prior to the event.

3. The system of claim 1 wherein the processing system is to include an indication of the location in the notification.

4. The system of claim 1 wherein the processing system is to associate the event with a device at the location.

5. The system of claim 1 wherein the processing system is to store the event in an event log.

6. The system of claim 1 wherein the processing system is to identify the location of the event using triangulation.

7. The system of claim 1 wherein the accelerometers each include a proof mass with a first electrode array suspended above a second electrode array disposed on a wafer.

8. The system of claim 1 wherein the accelerometers each include three-phase sensing and actuation.

9. The system of claim 1 wherein the accelerometers each detect changes in capacitances between a first electrode arrays disposed on a proof mass and a second electrode array disposed on a wafer.

10. A method performed by a processing system, the method comprising:
receiving current vibration data corresponding to an event from at least three accelerometers disposed in different locations of an area;
identifying the event and a location of the event by comparing the current vibration data to previous vibration data captured prior to the event; and
providing a notification based on the comparison.

11. The method of claim 10 further comprising:
including an indication of the location in the notification

12. The method of claim 10 further comprising:
associating the event with a device at the location.

13. The method of claim 10 further comprising:
identifying the location by triangulating the vibration data.

14. A computer-readable storage medium storing instructions that, when executed by a processing system, perform a method comprising:
receiving first vibration data captured by at least three accelerometers disposed in different locations of an area during a first event; and
storing a first notification corresponding to a first device in the area based on the first event and a first location of the first event identified from the first vibration data.

15. The computer-readable storage medium of claim 14, the method further comprising:
receiving second vibration data captured by the at least three accelerometers during a second event; and
storing a second notification corresponding to a second device in the area based on the second event and a second location of the second event identified from the second vibration data, the second location differing from the first location and the first device differing from the second device.
